(19) United States
(12) Patent Application Publication
(10) Pub. No.: US 2021/0406845 A1
(43) Pub. Date: Dec. 30, 2021

(54) Method for registering a ticket medium

(71) Applicant: Scheidt & Bachmann GmbH, Mönchengladbach (DE)

(72) Inventor: Martin Krivo{hacek over (s)}ik, Brestovany (SK)

(21) Appl. No.: 17/346,991

(22) Filed: Jun. 14, 2021

(30) Foreign Application Priority Data
Jun. 26, 2020 (DE) 10 2020 116 943.4

(51) Int. Cl. G06Q 20/04; G06Q 20/14; G06Q 20/40

(52) U.S. Cl. CPC G06Q 20/0457; G06Q 20/401; G06Q 20/145

(57) ABSTRACT

A method of registering a ticket medium for use of a transport service, including detecting, by a validator device of a transit system, at least one electronic medium identifier of an unregistered ticket medium used for a use of the transport service, transmitting an identification data set containing at least the detected electronic medium identifier to a computing device that generates and outputs a billing data set based at least on the transmitted electronic identification data set, wherein the billing data set contains at least one transaction identifier associated with the used transport service. At least the transaction identifier is associated to the electronic medium identifier and the association is stored. The computing device receives at least one registration message containing at least the transaction identifier of the output billing data set and determines the electronic medium identifier based on at least the at least one stored association and the transaction identifier of the received registration message. Registering the unregistered ticket medium by creating a user data set containing at least the determined electronic medium identifier.

### CROSS-REFERENCE TO RELATED APPLICATIONS

This application claims the benefit of German patent application No. 10 2020 116 943.4, filed Jun. 26, 2020, the full disclosure of which is incorporated herein by reference.

### TECHNICAL FIELD

The application relates to a method for registering a ticket medium for the use of a transport service. Furthermore, the application relates to a (central) computing device of a transit system and a transit system.

### BACKGROUND ART

Transit systems for performing transport services are known from the prior art. A transport service in a transit system is understood to mean, in particular, the use of a transport device, in particular, a transport vehicle (e.g., bus, train, aircraft, watercraft, etc.), by a user. In other words, a transit system may comprise at least one transport device for transporting users respectively persons.

In conventional (passenger) transit systems, in order to acquire an entitlement to use a transport service, a user may, typically prior to using the transport service, obtain the entitlement, for example, by purchasing a ticket. Exemplary and non-exhaustive entitlements in transit systems are single or multiple ride tickets as well as time-based tickets, such as weekly or monthly tickets.

Today, transit systems increasingly comprise ticketing systems in which ticket media with electronic user authorizations are used, such as electronic tickets. In variants of such transit systems, a user authorization can also be an electronic medium identifier of a (portable) ticket medium readable by a validator device, such as an electronic card identifier of a ticket medium in the form of a credit card and/or debit card, or an electronic identifier of a payment service application.

In principle, an authorized use of a transport service by a user can occur as follows: When the user enters a paid area (e.g., transport vehicle, a platform of a departure station, etc.), the electronic medium identifier stored on the ticket medium can be detected by a validator device of the transit system. The validator device may be installed at the at least one access point (e.g., entrance and/or exit) to the paid area. In particular, a validator device may have at least one ticket medium interface, such as a ticket medium reader, for example, in the form of a card reader. A ticket medium tapped to (with a sufficient range) or inserted into the reader can be read so that the stored electronic medium identifier can be detected. It shall be understood that a validator device may be formed with at least one blocking element (e.g., as an access blocker or a so-called “gate”) or without a blocking element (e.g., as a mere validator).

Upon exiting the paid area, the electronic medium identifier stored on the ticket medium may be detected again by a further or the same validator device of the transit system, as previously described.

For a billing of the used transport service, the at least one validator device can transmit the respective detected electronic medium identifier in the form of an identification data set to a (central) computing device of the transit system. Preferably, the identification data set can comprise further data, such as a system-wide unique identification number of the validator device and/or a detection time datum.

The computing device may, for example, be part of a backend system (also called background system) of the transit system and/or form the backend system. A billing module implemented on the computing device can, based on the electronic medium identifier (which may, in particular, comprise billing data, such as a credit card number or the like), the location data and/or time data, perform billing for the used transport service. For example, time-based and/or distance-based billing may be performed. It shall be understood that the billing may further be based on predetermined tariff data. This can then be billed to the user in a conventional manner, for example, in the form of a credit card bill.

In the described transit system, it is not necessary for the ticket medium to be registered in the transit system in order to use the transport service. However, the operation of the transit system can be simplified and, in particular, made more convenient and user-friendly for a user if a user is registered in the transit system. In the present case, a registration means, in particular, that the user's ticket medium used for the utilization respectively use of transport services is registered, i.e., in particular, a user data set (for example, in the form of a user account) is created which contains at least the electronic medium identifier of the ticket medium of the user.

A method for registering a ticket medium respectively the electronic medium identifier is known from document U.S. Pat. No. 8,991,699 B2. In this method, the transit system comprises specifically designed user terminals at which a user must first create a user account by entering user data. Subsequently, the user is prompted at the user terminal to hold the previously unregistered ticket medium to be used at a ticket medium interface of the user terminal in such a way that at least the electronic medium identifier of the unregistered ticket medium is detected. In particular, the ticket medium interface is specifically configured for reading at least the electronic medium identifier. The electronic medium identifier is usually not known to the user himself, but is only stored (unchangeably) in electronic form in a memory means of the ticket medium.

After the electronic medium identifier has been read, the medium identifier is assigned to the previously created user account in accordance with U.S. Pat. No. 8,991,699 B2 and, in particular, a user data set is stored containing the electronic medium identifier.

After a respective registration, the user can then use his registered ticket medium in the transit system to obtain transport services, as described at the beginning.

However, the disadvantage of the method described in U.S. Pat. No. 8,991,699 B2 is that the registration is time-consuming for the user and therefore not very user-friendly. A registration at a specially designed user terminal is necessary before a use. In addition, it is necessary for the transit system to comprise said specially designed user terminals, which entails an increased effort, space requirements and costs.

Therefore, embodiments of the present invention provide a method for registering a ticket medium for the use of a transport service, in which the aforementioned disadvantages are at least reduced and, in particular, a user-friendly and low-effort registration of the ticket medium is made possible.

### SUMMARY OF THE EMBODIMENTS

According to a first aspect of the present application, a method for registering a ticket medium for use of a transport service comprises:
detecting, by a validator device of a transit system, at least one electronic medium identifier of an unregistered ticket medium used for a use of the transport service,
transmitting an identification data set containing at least the detected electronic medium identifier to a computing device,
generating, by the computing device, a billing data set based at least on the transmitted electronic identification data set,
wherein the billing data set contains at least one transaction identifier associated with the used transport service,
associating, by the computing device, at least the transaction identifier to the electronic medium identifier,
storing, by the computing device, of at least the association of the electronic medium identifier to the transaction identifier,
outputting, by the computing device, the generated billing data set,
receiving, by the computing device, at least one registration message containing at least the transaction identifier of the output billing data set,
determining, by the computing device, the electronic medium identifier based on at least the at least one stored association of the transaction identifier to the electronic medium identifier and the transaction identifier of the received registration message; and
registering, by the computing device, the unregistered ticket medium by creating a user data set containing at least the determined electronic medium identifier.

In contrast to the prior art, according to the method according to the application, it is provided that the detection of an electronic identification data set, containing at least one (unique) electronic medium identifier, of a non-registered ticket medium is made in the course of a use of a transport service, and that a subsequent registration of this detected electronic medium identifier is made at least based on a transaction identifier of a billing data set generated (anyway) for the used transport service, so that the disadvantages of the prior art can at least be reduced.

In particular, a user-friendly and low-effort registration of the ticket medium is made possible. A specially formed user terminal with a specially formed ticket medium interface can be omitted. An installation of such user terminals as well as a provision of the necessary space for an installation can be omitted. Instead of such a user terminal, a validator device is used which is provided in any case.

The method according to the application serves, in particular, to register a user in a transit system. In the present case, this comprises, in particular, at least the registration of the ticket medium to be used for transport services by storing at least the electronic medium identifier stored in a memory means of the ticket medium in a data storage arrangement of the transit system.

An electronic medium identifier means, in particular, that it is stored in its entirety only in the memory means of the ticket medium (and, in particular, cannot be read optically (in its entirety) from the memory medium by a user). In particular, a ticket medium interface, for example, with a (contactless or contract-based) interface, is required for the detection of the electronic medium identifier. The (contactless or contract-based) interface corresponds to the ticket medium interface. Non-exhaustive examples of contact-based ticket medium interfaces are magnetic stripes and Europay Mastercard VISA chips (EMV chips); examples of non-contact-based ticket medium interfaces are Nearfield Communication interfaces (NFC interfaces) according to ISO 14443.

Furthermore, according to the application, the electronic medium identifier is, in particular, a (system-wide) unique electronic medium identifier. This means, in particular, that a ticket medium can be identified (system-wide) unambiguously by this medium identifier. In particular, an electronic medium identifier for credit cards and/or debit cards enables differentiation between so-called partner cards, each of which has the same credit card number but different electronic medium identifiers. In this case, however, the credit card number can be determined from the respective electronic medium identifier.

The ticket medium is, in particular, a portable medium with at least one readable memory means configured at least to store the electronic medium identifier. Preferably, the ticket medium may be a card-based ticket medium, such as a credit card-based and/or debit card-based ticket medium. Preferably, the ticket medium may be a credit card and/or a debit card. Also, the card-based ticket medium may be a mobile terminal on which a credit card and/or debit card is electronically mapped or to which a credit card and/or debit card is electronically (uniquely) linked. Non-exhaustive examples of such a concept are Apple Pay, Google Pay or PayPal.

Exemplary and non-exhaustive mobile terminals here comprise smartphones, tablet computers, mobile game consoles, laptops, netbooks, data glasses, smartwatches and similar wearables.

According to the application, such a medium identifier of a non-registered ticket medium is detected by a validator device. A validator device is a device of a transit system that is used anyway to detect the correct use of a transport service by a user. For example, a validator device may be located at an access point (e.g., an entrance and/or an exit) to a paid area. In particular, entering this area is equivalent to using a transport service. The paid area can be, for example, the interior of a transport device, or a (delimited) anteroom to a transport device, such as a platform or the like.

A detecting of the use of a transport service by a validator device comprises, in particular, a detecting of an electronic medium identifier, for example, in the course of a check-in process and/or check-out process. For a correct use of a transport service, it may be necessary, for example, for the user to check in to the transit system when entering the paid area, in particular, by having at least one electronic medium identifier detected by the validator device as part of a check-in process. Correspondingly, it may be necessary for the user to check out of the transit system when leaving the paid area, in particular, by at least one electronic medium identifier being detected by the validator device in the course of a check-out process. Here, a passage barrier can optionally be provided at the access, which in cooperation with the validator device (in a conventional manner) releases and/or blocks the access.

Furthermore, according to the application, the identification data set is transmitted to a computing device (located remotely from the validator device). The at least one validator device and the at least one computing device can be connected in terms of communication via at least one (wireless and/or wired) communication network. The at least one computing device may, in particular, be at least a part of a backend system. A backend system may comprise—as a computing device—one or more (distributed) server(s).

Preferably, the at least one identification data set can comprise further data, which, in particular, enable a billing of the used transport service. In particular, the identification data set can contain a time datum, in particular, in the form of a time stamp. The time stamp (e.g., calendar date and clock) can, in particular, indicate the time of detection of the medium identifier by the validator device.

Alternatively or preferably additionally, the identification data set may comprise a location datum of the validator device (detecting the medium identifier). A location datum and site datum, respectively, means, in particular, an indication from which the (current) location and installation site, respectively, of the validator device can at least be derived, i.e. the location during the detection of the medium identifier. For example, the location datum may comprise a validator device identifier from which the location of the validator device can be derived using a location database. Alternatively or additionally, the location datum may comprise geographic position data (e.g., GPS coordinates).

In particular, for mobile validator devices, i.e., those installed in transport vehicles, the location datum can be determined from on-board infrastructure; alternatively, the location datum can be determined from the time stamp and traffic system operations data in the backend system.

Furthermore, according to the application, generating of a billing data set takes place. In particular, the billing data set can be generated for billing and then output by the computing device (to the corresponding user). According to the application, the billing data set is generated in such a way that it can (additionally) be used for a registration of the ticket medium.

Thus, according to the application, it is provided that a billing data set is generated, at least based on the transmitted electronic identification data set and, in particular, the used transport service (e.g., based on the mentioned time datum and/or location datum). In addition, a transaction identifier is generated, in particular, for the billing data set and added to the billing data set. The transaction identifier is used to identify the used (and billed) transport service. In addition, according to the application, the transaction identifier is associated to the detected electronic medium identifier (on which the corresponding billing data set is based). In this way, in particular, the electronic medium identifier can be identified by the transaction identifier.

This association is stored by the computing device, at least for a specific period of time. After this period of time has expired, the stored data can be deleted. In other words: the registration according to the application can preferably only take place within the specific period of time after the generating of the billing data set. Storing of the association means, in particular, that at least the transaction identifier is stored together with the electronic medium identifier. For example, transaction identifier and associated medium identifier form a data tuple.

Storing by the computing device means, in particular, that a memory module can control the storing of the at least one association. For example, the computing device may have a data storage arrangement and/or be communicatively connectable to a data storage arrangement.

According to the application, the generated billing data set is output in the form of an account statement. The account statement refers to the ticket medium (to be registered) that was used for the use of the transport service. In particular, the account statement can be a credit card statement and/or a debit card statement and/or the statement of a payment service application.

Upon a receipt of a registration message by the computing device, the content of the registration message is evaluated. The registration message contains at least the transaction identifier of the output billing data set. For example, the registration message may be generated by a further computing device of the user in the form of a user terminal and transmitted to the computing device, in particular, via a (wireless and/or wired) communication network.

It should be emphasized here, in particular, that, in the method according to the application, the further computing device of the user does not need to have a ticket medium interface.

Upon a receipt of a registration message, the medium identifier to be registered is determined based on the received transaction identifier and the at least one stored association. In particular, it is determined as to whether a transaction identifier corresponding to (in particular, being identical to) the received transaction identifier is stored.

According to one embodiment of the method according to the application, determining the electronic medium identifier may comprise at least comparing the transaction identifier of the received registration message with the at least one stored transaction identifier of the at least one stored association.

If no correspondence (in particular, identity) is determined between the received transaction identifier and one of the stored transaction identifiers, the method can be aborted. For example, a (negative) response message may be sent as a response to the registration message. The response message may contain information indicating that a registration has failed.

If a correspondence (in particular, identity) is determined between the received transaction identifier and one of the stored transaction identifiers, in particular, a registration of at least the ticket medium is performed by storing at least the electronic medium identifier associated with the particular stored transaction identifier. The registration comprises creating a user data set, preferably, in the form of a user account, which comprises at least the electronic medium identifier. For example, a (positive) response message may be sent as a response to the registration message. The response message may contain information indicating that a registration has been successful.

According to a preferred embodiment of the method according to the application, creating a user data set, in particular, in the form of a user account, may (additionally) comprise storing at least one further user datum. The at least one further user datum may be selected from the group comprising:
user name,
address data of the user, in particular, a communication address,
user password,
billing data, and
transport service tariff data,
account data,
data of at least one further payment medium,
association to a user group (e.g., a specific fare group, such as students, frequent travelers, etc.).

Preferably, the at least one registration message may comprise at least one datum of the aforementioned user data. Here, it may be provided that after an initial registration of the determined electronic medium identifier, the user is requested, for example, by a request message, to provide at least one further user datum. Here, the input of at least part of the data may be optional. In particular, during a registration process, a plurality of messages may be exchanged between the further computing device of the user and the computing device of the transit system.

Preferably, based on an evaluation of the at least one transport service already used, at least one tariff option optimized for the user can be proposed to the user. After a tariff option has been confirmed, it can be stored as a transport service tariff datum in the user data set.

According to a further embodiment of the method according to the application, the transaction identifier may be a unique transaction identifier. Each billing data set may be associated with, i.e., comprise, a unique transaction identifier. In other words, each transaction data set and billing data set, respectively, may be uniquely identifiable by the transaction identifier at least throughout the transit system. This subsequently enables registration of the electronic medium identifier only on the basis of the transaction identifier. An evaluation of further data can be omitted. In particular, the transaction identifier can be uniquely identifiable throughout the transit system (only) for the duration of the specific period of time after the generating of the billing data set within which registration is possible.

According to a preferred embodiment of the method according to the application, the (generated) billing data set may contain at least one further billing datum. According to a particularly preferred embodiment of the method according to the application, the at least one further billing datum can be a billing datum from the group comprising:
an amount payable for the used transport service,
a tariff characteristic applied to the used transport service,
a time datum related to the used transport service (e.g., time stamp of the start of the trip, time stamp of the end of the trip, duration of the trip, etc.),
a location datum related to the used transport service (e.g., start location of the trip, destination location of the trip, distance traveled, etc.).

For example, by including in the billing data set the amount to be paid for the used transport service it can be paid by users. In addition, further information about the at least one used transport service can be contained in the billing data set. In particular, this may be at least one tariff characteristic on which the amount to be paid is based, such as the at least one fare zone used, start and/or destination of the trip, and/or other tariff characteristics that are determinative for the price of the used transport service. This enables the user, for example, to better understand the amount to be paid for the used transport service.

Furthermore, it has been recognized according to the application that the at least one billing datum (provided anyway) in a billing data set can also be taken into account during the registration, in particular, the evaluation of the registration message and the determining of the medium identifier. As will be explained below, this may, for example, obviate the need for the transaction identifier to be a unique transaction identifier. Alternatively, in the case of a unique transaction identifier, an additional (redundant) verification of the evaluation of this transaction identifier can be performed.

According to a preferred embodiment of the method according to the application, in the presence of at least one further billing datum, associating may comprise at least associating the transaction identifier and the further billing datum to the electronic medium identifier. In other words, a memory data set is formed containing the transaction identifier of a billing data set, the at least one further billing datum of the billing data set (possibly at least one still further billing datum of the billing data set) and the electronic medium identifier for which the billing data set is generated.

The system-wide unique data key that allows a customer to be registered to the electronic medium identifier based on the billing data set consists, in this case, of the transaction identifier and the at least one additional billing datum of the billing data set. In particular, in this embodiment, the transaction identifier may be shorter (and thus more user-friendly) if it does not need to be unique by itself.

In particular, storing comprises at least storing the association from the electronic medium identifier to the transaction identifier and the at least one further billing datum. In other words, at least the aforementioned memory data set is stored by the computing device in the at least one data storage arrangement.

Preferably, the at least one registration message may comprise at least the transaction identifier and the further billing datum. Then, determining the electronic medium identifier may comprise at least a determining of the electronic medium identifier based on the at least one stored association of the electronic medium identifier to the transaction identifier and the further billing datum and on the the transaction identifier and the further billing datum of the received registration message.

In one embodiment, it may also be provided that the initial registration message contains only the transaction identifier. If the evaluation determines that the transaction identifier exists multiple times, for example, is associated to different electronic medium identifiers, a request message may be sent to receive at least one further billing datum. Upon receipt of a further registration message, containing the at least one (requested) further billing datum, in response to this request message, the evaluation may continue. In particular, the at least one further billing datum may be used to determine (uniquely) the electronic medium identifier to be registered. The medium identifier thus determined can then be registered.

In a simple way, registration can be done by taking into account the billing data already present in a billing data set during the registration process.

According to a particularly preferred embodiment of the method according to the application, the electronic medium identifier may be an encoded Primary Account Number (encoded PAN). The encoded PAN contains the known readable PAN printed, embossed or engraved on a debit card or credit card, plus additional encoded data, such as the card sequence number that identifies the present card individual. The encoded PAN must therefore be read electronically from the card and is not human-readable.

In particular, the encoded PAN uniquely identifies ticket media, such as individual credit cards and/or debit cards and/or (aforementioned) mobile terminals. A validator device can, in particular, read at least the encoded PAN by a PAN interface. From the encoded PAN, in particular, with the aid of databases, the country, credit institution, bank code and/or account number can be determined. In a simple way, a billing of a transport service can be enabled.

According to a further embodiment of the method according to the application, the method may further comprise:
checking, by the computing device, whether an amount to be payable for the used transport service has been paid within a specific period of time, and
sending, by the computing device, a blocking message to the at least one validator device in such a way that the use of the ticket medium is blocked at the at least one validator device.

In particular, in order to prevent further use of transport services or at least to make it more difficult if the user has not paid the amount to be paid for the used transport service within a specific period of time, a blocking message can be sent to preferably all validator devices of the transit system. The blocking message may contain at least the medium identifier to be blocked. This may be stored in a local data memory of the at least one validator device. Before an access is released, for example, through a passage barrier, to a paid area, for example, a validation of the detected medium identifier may be performed, for example, by a comparison operation. If it is determined that this corresponds (e.g., is identical) to a stored (invalid) medium identifier, the access can remain blocked. It can also be indicated on a display device of the validator device that the (desired) transport service may not be used with the used ticket medium. Further measures can then be initiated.

A further aspect of the application is a computing device of a transit system. The computing device comprises:
at least one identification receiving module configured to receive an electronic identification data set, generated by a validator device of the transit system, of an unregistered ticket medium used to use a transport service,
wherein the electronic identification data set contains at least one (unique) electronic medium identifier of the unregistered ticket medium detected by the validator device,
at least one billing module configured to generate a billing data set based at least on the received electronic identification data set and the used transport service,
wherein the billing data set contains at least one transaction identifier associated with used the transport service,
at least one associating module configured to associate at least the transaction identifier to the electronic medium identifier,
at least one memory module configured to store at least the association of the electronic medium identifier to the transaction identifier,
at least one output module configured to output the generated billing data set,
at least one registration receiving module configured to receive at least one registration message containing at least the transaction identifier of the output billing data set,
at least one evaluation module configured to determine the electronic medium identifier based at least on the at least one stored association of the transaction identifier to the electronic medium identifier and the transaction identifier of the received registration message, and
at least one registration module configured to register the unregistered ticket medium by creating a user data set containing at least the determined electronic medium identifier.

In particular, the method may be performed at least in part by the computing device. The computing device may be formed by two or more computing units and computers, respectively (e.g., in the form of servers). In particular, said modules may be arranged at least partially distributed on two or more computing units and computers, respectively (e.g., in the form of servers).

A still further aspect of the application is a transit system. The transit system comprises:
at least one previously described computing device, and
at least one validator device configured to detect an electronic identification data set of an unregistered ticket medium which is used for a use of a transport service.

In particular, the method can be carried out by or in the transit system.

A module or device can be formed at least partially by software and/or at least partially by hardware. In particular, a device/element may comprise suitable computing elements (e.g., processor, memory, etc.) to execute software elements (or computer code).

The features of the methods, transit systems and computing devices can be freely combined with each other. In particular, features of the description and/or the dependent claims can be independently inventive, even by completely or partially circumventing features of the independent claims, in sole position or freely combined with each other.

### BRIEF DESCRIPTION OF THE DRAWINGS

The foregoing features of embodiments will be more readily understood by reference to the following detailed description, taken with reference to the accompanying drawings, in which:

FIG. 1 is a schematic view of an embodiment of a transit system according to the present application with an embodiment of a computing device according to the present application.

FIG. 2 is a diagram of an embodiment of a method according to the present application.

### DETAILED DESCRIPTION OF SPECIFIC EMBODIMENTS

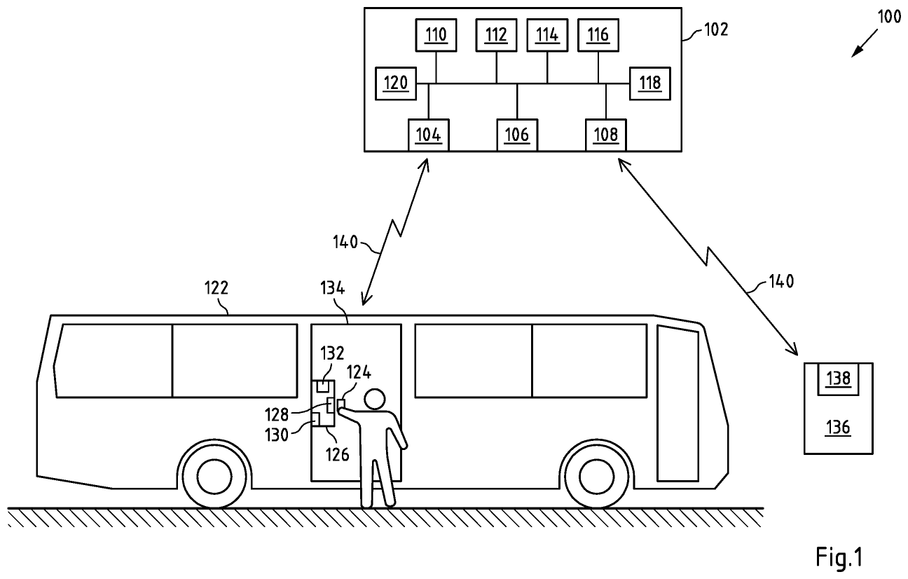

FIG. 1 shows a schematic view of an embodiment of a transit system 100 according to the present application, with an embodiment of a computing device 102 according to the present application.

The illustrated transit system 100 comprises at least one computing device 102 and at least one validator device 126. Further, the transit system 100 may comprise at least one transport device 122, by way of example herein in the form of a bus 122. It shall be understood that a transit system 100 may alternatively or additionally comprise other transport devices (e.g., cable car, train, watercraft, etc.).

In the present example, the at least one validator device 126 is arranged within the transport vehicle 122. As can be seen, the at least one validator device 126 is arranged at an access 134 (e.g., entrance and/or exit) of the transport vehicle 122 to a paid area, preferably, the interior of the transport vehicle 122. Preferably, at least one validator device 126 may be arranged at each access 134 of a transport vehicle 122. In other variants, the validator device may also be arranged in a station or the like.

During operation of the transit system 100, a user of the transportation vehicle 122 may check-in for an authorized use of the transport service when boarding the transport vehicle 122. To do so, the user may, in particular, bring his ticket medium 124, in particular, within the reach of a ticket medium interface 128 of the validator device 126.

The at least one ticket medium interface 128 may be a contact-based or contactless ticket media interface 128. It shall be understood that two or more ticket medium interfaces may be provided for a corresponding number of different ticket media.

In particular, by the ticket medium interface 128, at least one electronic medium identifier of the ticket medium 124 may be detected in the check-in process.

The validator device 126 may comprise at least one communication module 132 and/or be connectable to at least one (not shown) communication module. The communication module 132 may at least be configured to transmit a detected electronic (unique) medium identifier, preferably, together with further data, to a (central) computing device 102 of a backend system of the transit system. In particular, transmitting a corresponding identification data set takes place.

Further data of the identification data set may, in particular, be a time stamp (e.g., a calendar date and clock of the detection time point) and/or at least one location datum from which the location of the validator device (and the transport vehicle 122, respectively) during the detection of the electronic medium identifier can at least be derived.

Optionally, the validator device 126 may comprise at least one local data memory 130. The at least one data memory 130 may store a list of blocked respectively unauthorized electronic medium identifiers. When the electronic medium identifier is detected, it may be compared to the stored and blocked medium identifiers. If a correspondence (particularly identity) is detected, the computing device 102 may be informed accordingly.

A display device (not shown) of the validator device 126 may alternatively or additionally indicate that the ticket medium 124 is not authorized for correct use of the transport vehicle 122.

In other variants of the application, an access device (e.g., a passage barrier) may additionally be provided. This can only be released if it is determined during the comparing process that the detected electronic medium identifier is not a blocked medium identifier.

When leaving the transport vehicle 122, the user can check-out, in particular, analogously to the check-in process described above. In a corresponding manner, a validator device (for example, the same validator device 126) can transmit at least the electronic medium identifier, preferably, together with the mentioned further data to the backend system. In particular, transmitting a (further) identification data set takes place.

In the case of an inspection by an inspector, the inspector can use a (not shown) inspection device to retrieve, in particular, receive, the medium identifiers transmitted to the computing device 102 and use them for the inspection. In particular, the ticket media can be inspected by the inspection device by reading the respective medium identifier and comparing them with the medium identifiers received from the computing device. If it is determined here that a user has not checked in and/or has a ticket medium with a blocked medium identifier, the inspector can take known measures.

The illustrated computing device 102 comprises a plurality of modules 104 to 120 (possibly arranged in a distributed manner). Thus, at least one identification receiving module 104 is provided at least configured to receive an identification data set generated by a validator device 126 of the transit system 100. As has been described, this may contain at least the detected electronic medium identifier of a (non-registered and/or registered) ticket medium 124 used for a use of a transport service.

Furthermore, at least one billing module 110 is provided at least configured to generate a billing data set at least based on the received medium identifier and, in particular, the used transport service.

In the case of a medium identifier that has already been registered, for generating the billing data set it can be, preferably additionally, accessed, by the billing module 110, a user data set, in particular, in the form of a user account that has already been stored. The billing data set contains at least one transaction identifier associated with the used transport service. The transaction identifier can be generated by a (not shown) generation unit during the generation of the billing data set according to a predefined rule and/or selected from a pre-stored list of transaction identifiers.

The computing device 102 comprises at least one associating module 112 configured to associate at least the transaction identifier to the electronic medium identifier.

Further, at least one memory module 114 is provided in the computing device 102 configured to store at least the association of the electronic medium identifier with the transaction identifier, preferably in a data storage arrangement 120. By way of example, the computing device 102 comprises the data storage arrangement 120. The at least one user data set may additionally be storable in the data storage arrangement 120.

The computing device 102 further comprises at least one output module 106 configured at least to output the generated billing data set, in particular, to the corresponding user. For example, outputting may comprise (directly or indirectly) transmitting of the generated billing data set to a further computing device 136, in particular, a user terminal 136 (e.g., a computer, tablet, smartphone, etc.) of the user. The user terminal 136 may comprise at least one communication module 138. It shall be understood that the billing data set may also be output to the user in other ways.

Further, the computing device 102 comprises at least one registration receiving module 108. The registration receiving module 108 is configured to receive at least one registration message (in particular, from a user terminal 136) containing at least the transaction identifier of the output billing data set.

As further shown in FIG. 1, the computing device 102 comprises at least one evaluation module 116 configured to determine the electronic medium identifier based at least on the at least one stored association from the transaction identifier to the electronic medium identifier and the transaction identifier of the received registration message.

The computing device 102 further comprises at least one registration module 118 configured to register the unregistered ticket medium 124 by creating a user data set containing at least the determined electronic medium identifier. As has been described, this may be stored in the data storage arrangement 120, for example.

As can be further seen, at least one communication network 140 (wireless and/or wired) may be provided to enable a communication between at least the illustrated elements 102, 126, 136.

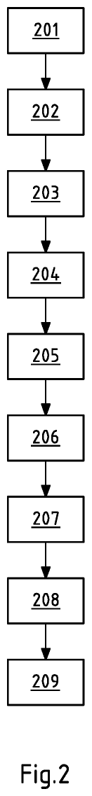

The operation of the transit system 100 according to FIG. 1, in particular, a registration process according to the application, is described in more detail below with the aid of FIG. 2.

FIG. 2 shows a diagram of an embodiment of a method, in particular, for registering a (previously) unregistered ticket medium 124 in a transit system 100. In this example, the ticket medium 124 is a credit card 124 with an encoded PAN stored in a memory means of the credit card. This can be detected via a (contact-based or contactless) interface.

It shall be understood that in other variants of the application other ticket media can be used alternatively or additionally, as has already been described.

In a first step 201, a detecting, by a validator device 126 of a transit system 100, of at least the electronic medium identifier of an unregistered ticket medium used for a use of the transport service occurs. As it is described above, the detecting may be performed by a ticket medium interface 128. For example, the electronic medium identifier in the form of the encoded PAN is detected in the course of a check-in process and/or check-out process described above.

In a further step 202, a transmitting of an identification data set takes place containing at least the detected electronic medium identifier to a computing device 102 of a backend system. As has already been described, the computing device 102 may form the backend system of the transit system 100.

For example, the communication module 132 of the validator device 126 may generate the identification data set immediately after detecting the electronic medium identifier. The communication module 132 may then transmit the generated identification data set containing at least the detected electronic medium identifier via the at least one communication network 140.

Preferably, the identification data set may additionally comprise a pre-described location datum and time datum. For this purpose, the validator device may, for example, have suitable means, such as a clock and/or position sensor. As has been described, a location datum may also be determinable from a validator device identifier. The identification receiving module 104 of the computing device 102 receives the generated and transmitted identification data set.

Upon receipt of the transmitted identification data set, in step 203 a generating, by the computing device 102 (in particular, by the billing module 110), of a billing data set takes place, at least based on the transmitted electronic identification data set and, in particular, the used transport service.

Preferably, the billing module 110 may be configured to generate a billing data set based on two received identification data sets each containing the same electronic medium identifier. The first identification data set may be a check-in identification data set detected and generated, respectively, during the check-in process described above with a particular (previously unregistered) ticket medium 124.

The second identification data set may be a check-out identification data set detected and generated, respectively, during the check-out process described above using that particular ticket medium 124. In particular, a billing data set may be generated by the billing module 110 from the respective location datum and/or time datum (and a tariff information) of the first identification data set and second identification data set. This may, in particular, contain an amount to be paid for the used transport service.

Further, the billing module 110 may, in particular, generate a transaction identifier and add it to this billing data set. Preferably, the billing data set may contain at least the transaction identifier and the amount to be paid. These two data together may be (nearly) unique system-wide. In other words, this data tuple can uniquely identify the billing data set and, in particular, the associated electronic medium identifier (as will be explained below).

As has already been explained, a billing data set may contain additional data, such as information about the used and billed transport service (e.g., trip distance, applied tariff, time period, etc.).

In step 204, an associating, by the computing device 102, of at least the transaction identifier to the electronic medium identifier of the at least one received identification data set occurs. In particular, the associating module 112 is configured to do this. Preferably, the data tuple containing the transaction identifier and the amount to be paid (and/or another billing data) can be associated to the corresponding electronic medium identifier.

This association, in particular, said data tuple and the electronic medium identifier, is/are stored in step 205, by the computing device. In particular, the memory module 114 controls the storing of this association, preferably in a data storage arrangement 120. The data storage arrangement 120 may be controlled by the memory module 114 and/or another module.

In step 206, the generated billing data set is output by the computing device 102. The outputting takes place, by the output module 106, in particular, in such a way that the user of the ticket medium 124 is informed of the content of the billing data set. For example, a billing message may be sent via a communication network 140.

At step 207, a receiving, by the computing device 102, of at least one registration message occurs containing at least the transaction identifier of the output billing data set. In particular, a registration receiving module 108 receives a registration message. Advantageously, a user terminal 136 may generate the registration message and, in particular, send the registration message via the at least one communication network 140. For example, the user may manually enter the transaction identifier and preferably said amount using a user interface of the user terminal 136.

In other variants of the application, this data may also be detected automatically. Further, in other variants, the at least one registration message may comprise further user data, such as user name, address data, billing data, etc. It shall be understood that two or more registration messages may be sent, as previously explained.

Upon a receipt of a registration message, an evaluating of the content of the received registration message occurs by the computing device 102 in step 208.

Thus, the electronic medium identifier is determined by the evaluation module 116 based at least on the at least one stored association of the transaction identifier with the electronic medium identifier and the transaction identifier of the received registration message. In particular, in the present example, a comparing of the received data tuple containing transaction identifier and amount is performed with the stored data tuples containing transaction identifier and amount, respectively. In particular, when identity is determined between the received data tuple and a stored data tuple, the electronic medium identifier associated with that stored data tuple is determined as the electronic medium identifier to be registered.

After a determination of the electronic medium identifier to be registered, a registration, by the computing device 102, of the unregistered ticket medium 124 is performed in step 209 by creating a user data set containing at least the determined electronic medium identifier.

Preferably, by the registration module 118, a user data set can be created that includes further user data, such as user name, address data, billing data, etc.

What is claimed is:

1. A method of registering a ticket medium for use of a transport service,
comprising:
detecting, by a validator device of a transit system, at least one electronic medium identifier of an unregistered ticket medium used for a use of the transport service,
transmitting an identification data set containing at least the detected electronic medium identifier to a computing device,
generating, by the computing device, a billing data set based at least on the transmitted electronic identification data set,
wherein the billing data set contains at least one transaction identifier associated with the used transport service,
associating, by the computing device, at least the transaction identifier to the electronic medium identifier,
storing, by the computing device, of at least the association of the electronic medium identifier to the transaction identifier,
outputting, by the computing device, the generated billing data set,
receiving, by the computing device, at least one registration message containing at least the transaction identifier of the output billing data set,
determining, by the computing device, the electronic medium identifier based on at least the at least one stored association of the transaction identifier to the electronic medium identifier and the transaction identifier of the received registration message; and
registering, by the computing device, the unregistered ticket medium by creating a user data set containing at least the determined electronic medium identifier.

2. The method according to claim 1, wherein the determining of the electronic medium identifier comprises at least a comparing of the transaction identifier of the received registration message with the at least one stored transaction identifier.

3. The method according to claim 1, wherein creating a user data set comprises storing at least one further user datum, wherein the at least one further user datum is selected from the group, comprising:
user name,
address data of the user,
user password,
billing data,
transport service tariff data,
account data,
data of further payment media,
association to a user group.

4. The method according to claim 1, wherein the transaction identifier is a unique transaction identifier.

5. The method according to claim 1, wherein the outputting of the generated billing data set is in the form of an account statement.

6. The method according to claim 1, wherein
the billing data set contains at least one further billing datum,
wherein the associating comprises at least an associating of the transaction identifier and the further billing datum to the electronic medium identifier,
wherein the storing comprises at least a storing of the association of the electronic medium identifier to the transaction identifier and the further billing datum,
wherein the registration message contains at least the transaction identifier and the further billing datum, and
wherein the determining of the electronic medium identifier comprises at least a determining of the electronic medium identifier based on the at least one stored association from the electronic medium identifier to the transaction identifier and the further billing datum and on the transaction identifier and the further billing datum of the received registration message.

7. The method according to claim 6, wherein the at least one further billing datum is a billing datum from the group, consisting of:
an amount to be payable for the used transport service,
a tariff characteristic applied to the used transport service,
a time datum related to the used transport service, and
a location datum related to the used transport service.

8. The method according to claim 1, wherein the electronic medium identifier is a coded Primary Account Number PAN.

9. The method according to claim 1, further comprising:
checking, by the computing device, whether an amount to be payable for the used transport service has been paid within a specific period of time, and
sending, by the computing device, a blocking message to the at least one validator device in such a way that the use of the ticket medium is blocked at the at least one validator device.

10. A computing device of a transit system, comprising:
at least one identification receiving module configured to receive an electronic identification data set, generated by a validator device of the transit system, of an unregistered ticket medium used to use a transport service,
wherein the electronic identification data set contains at least one electronic medium identifier of the unregistered ticket medium detected by the validator device,
at least one billing module configured to generate a billing data set based at least on the received electronic identification data set and the used transport service,
wherein the billing data set contains at least one transaction identifier associated with used the transport service,
at least one associating module configured to associate at least the transaction identifier to the electronic medium identifier,
at least one memory module configured to store at least the association of the electronic medium identifier to the transaction identifier,
at least one output module configured to output the generated billing data set,
at least one registration receiving module configured to receive at least one registration message containing at least the transaction identifier of the output billing data set,
at least one evaluation module configured to determine the electronic medium identifier based at least on the at least one stored association of the transaction identifier to the electronic medium identifier and the transaction identifier of the received registration message, and
at least one registration module configured to register the unregistered ticket medium by creating a user data set containing at least the determined electronic medium identifier.

11. A transit system including at least one computing device according to claim 10, the transit system further comprising:
at least one validator device configured to detect an electronic identification data set of an unregistered ticket medium used to use a transport service.
